(19) United States
(12) Patent Application Publication
(10) Pub. No.: US 2022/0371944 A1
(43) Pub. Date: Nov. 24, 2022

(54) CHEMICALLY DURABLE, LOW-E COATING COMPATIBLE BLACK ENAMEL COMPOSITIONS

(71) Applicant: SAINT-GOBAIN GLASS FRANCE, COURBEVOIE (FR)

(72) Inventors: Jin Woo HAN, Seoul (KR); Eunhack JANG, Gunsan-si (KR)

(21) Appl. No.: 17/772,321

(22) PCT Filed: Nov. 27, 2020
(86) PCT No.: PCT/KR2020/017152

§ 371 Date: Apr. 27, 2022

(30) Foreign Application Priority Data
Nov. 29, 2019 (KR) 10-2019-0156832

(51) Int. Cl. C03C 8/04; C03C 8/14

(52) U.S. Cl. CPC C03C 8/04; C03C 8/14; C03C 2204/04; C03C 2205/02

(57) ABSTRACT

A black enamel composition includes a glass frit, a black pigment and an organic vehicle, wherein the glass frit includes 50 to 70 wt % of Bi₂O₃, 7.0 to 10.0 wt % of SiO₂, 6.0 to 8.0 wt % of B₂O₃, 10.0 to 15.0 wt % of ZnO, 1.0 to 2.0 wt % of Al₂O₃, 3.2 to 10.9 wt % of the total of Co₃O₄, NiO₂ and Fe₂O₃, based on the total weight of the glass frit, wherein the black pigment is 3 to 10 wt % relative to the total weight of the glass frit.

### TECHNICAL FIELD

The present invention relates to an enamel. Specifically, it relates to a composition for a black enamel coating that is suitable for application on a low-emission or Low-E (low emissivity) coating and has excellent chemical durability.

### BACKGROUND ART

Enamels can be used in a variety of applications, such as decorative pigments for glass products and ceramics. They are also often used in automobile industry or construction industry to coat glass substrates such as window glass. For example, an enamel is used as a colored periphery coated around glass sheets arranged in automobiles. These colored edges not only hide adhesives from visible to the outside to make the appearance look good but also prevent the underlying adhesives from being degraded by UV radiation of sunlight. Furthermore, enamel compositions can also be used with a silver (Ag) based coating that serves as a conductive coating for a defrost circuit arranged, for example, in a windshield or rear pane of motor vehicles.

Typically, an enamel composition comprises a glass frit, a colorant and an organic vehicle. The enamel composition is applied to a substrate, followed by firing to burn the organic vehicle and fusing the frit to the substrate, thereby bonding the enamel coating to the substrate.

A glass sheet for an automobile is usually coated with a ceramic enamel composition and then subjected to a pressure molding process while the temperature increased. During this treatment, the enamel is melted and fused to the glass substrate and the glass is shaped into the desired final shape. After heat treatment performing of curving and tempering, a phenomenon may occur in which the enamel layer cannot completely conceal the lower part it covers.

A black enamel is often applied in industrial fields. In order to sufficiently exhibit the effect expected therefrom, it is preferable to use an opaque black enamel having excellent optical properties in terms of color or opacity (light transmittance). In addition, it is advantageous in terms of aesthetics and extended applicability such as lamination that the enamel-coated surface is formed smoothly. Furthermore, it is necessary to have durability against damage caused by chemicals that may be in contact with enamels during the coating process and/or when coated enamels are used. In addition, an enamel composition having a large process margin during enamel coating is very beneficial from an economic point of view.

Low-E coating glass with improved heat insulation performance are widely used, where a special metal film having high infrared reflectance (generally silver is included) is coated on glass. Low-E coating films usually are formed in a structure of ‘glass/dielectric/silver/dielectric’. The Low-E performance is realized mostly by a silver layer located between the dielectric layers. According to the number of the silver layers, there are single Low-E (for example, Dura+ from Hankook Glass Industry Co., Ltd.) or multiple Low-E such as double Low-E (for example, SKN 154II from Hankook Glass Industry Co., Ltd.) and triple Low-E. An enamel is often formed on such Low-E coated glass.

U.S. Pat. No. 5,141,798 discloses black enamel compositions used for a flat glass having a conductive track formed of silver. However, it contains a large amount of a lead component known as a toxic substance in the components of the disclosed enamel compositions. In addition, chemical durability or process margin of the enamel compositions was not taken into account.

Korean Patent No. 1888701 discloses enamel compositions for ceramic glass containing a glass frit and a black pigment. The aesthetic aspect of the enamel after firing was considered, but chemical durability or process margin was not considered at all.
(patent document 0001) U.S. Pat. No. 5,141,798
(patent document 0002) Korean Patent No. 1888701

### DISCLOSURE OF INVENTION

### Technical Problem

The inventors of the present invention found that the color of an enamel gradually become yellowish brown as a tempering time increased (yellow shift) when an enamel composition printed on a Low-E coated substrate containing silver and then fired. This yellow shift phenomenon adversely affects the color and opacity of a black enamel.

### Solution to Problem

Accordingly, an object of the present invention is to solve this problem and to provide black enamel compositions having excellent color after tempering and suitable for a Low-E coated substrate and an article coated with the compositions. In addition, it is another object of the present invention to provide black enamel compositions having excellent surface quality with the surface roughness (Ra) of the enamel coating of an enamel-coated article being sufficiently low and an article coated with the compositions.

Another object of the present invention is to provide black enamel compositions with excellent chemical durability of the enamel-coated article and an article coated with the compositions.

Another object of the present invention is to provide black enamel compositions having a large process margin when forming a black enamel on a Low-E coated substrate and an article coated with the compositions.

The object of the present invention is not limited to the above-mentioned objects. Objects of the present invention will become more apparent from the following description and will be realized by the elements described in claims and combinations thereof.

The present invention may include the following elements to achieve the above object.

The present invention can be used when it is necessary to form a black enamel coating on a substrate or article with a Low-E coating. In an embodiment according to the present invention, an enamel composition comprises a glass frit, a black pigment and a vehicle, where the glass frit contains 50 to 70% by weight of Bi₂O₃, 7.0 to 10.0% by weight of SiO₂, 6.0 to 8.0% by weight of B₂O₃, 10.0 to 15.0% by weight of ZnO, 1.0 to 2.0% by weight of Al₂O₃ and a total of 3.2 to 10.9% by weight of Co₃O₄, NiO₂ and Fe₂O₃, and the black pigment may be an enamel composition of 3 to 10% by weight based on the total weight of the glass frit.

The enamel composition according to the present invention can be suitably used with a silver-based substrate or coating, for example a Low-E coating.

The enamel composition according to the present invention, in order to express a black color, has technical features of including transition metal oxides added as a member of a network of glass frit and a black pigment that is physically mixed with the glass frit.

For the black color of the enamel, the three transition metal oxides Co₃O₄, NiO₂ and/or Fe₂O₃ contained in the glass frit of the enamel composition of the present invention may be used in an amount of 3.0 to 6.0% by weight of Co₃O₄, 0.1 to 3.0% by weight of NiO₂ and 0.1 to 5.0% by weight of Fe₂O₃ with respect to the total weight of the glass frit.

In addition, in an embodiment of enamel compositions according to the present invention, the black pigment comprises Cr and one or more compounds may be selected from compounds comprising at least one of Zn, Fe, and Cu. The black pigment is used by being physically mixed with the glass frit.

The enamel composition according to the present invention may further include at least one selected from TiO₂ and Na₂O in the glass frit in an amount of 0.1 to 3.0% by weight, respectively.

The present invention also provides a coated article comprising a substrate, a Low-E coating formed on the substrate, and a pattern portion, wherein a coating of a black enamel composition according to the present invention is formed in a predetermined pattern on at least a part of the Low-E coated substrate. Here, the thin film Low-E coating on the enamel coating may be removed.

The method of making enamel-coated articles according to the present invention comprises the steps of printing a composition for forming a black enamel coating according to the present invention to produce a predetermined pattern on at least a portion of the Low-E coated substrate; and of forming a pattern portion including a black enamel coating by thermal treatment of the substrate on which the composition for forming the Low-E coating and the black enamel coating is printed.

### Advantageous Effects of Invention

The present invention has advantageous effects as described below.

When enamel compositions according to the present invention are applied to a silver-based coating such as a Low-E coating or to a substrate, the color of an enamel does not shift yellow and is expressed as an appropriate black color according to the increase of the tempering time, and the coated enamel has low transmittance and low surface roughness, so that it has good aesthetics and excellent shielding function.

In addition, when enamel compositions according to the present invention are applied to a Low-E coating, it is possible to use a small amount of black pigment while having an appropriate black color suitable for use. The enamel formed of the enamel compositions according to the present invention has high chemical durability as the chemical durability of an enamel decreases when the content of a pigment is high.

Furthermore, since enamel compositions according to the present invention have a wide range of tempering time that can maintain the range of the glass side reflection color (CIELAB color coordinates a* and b*, respectively −1.0 to 1.0) required for an enamel of a coated article, the process margin is large. As such, there are advantages that the process is easy and the enamel compositions can be used in a wide variety of products.

Advantage of enamel compositions according to the present invention is suitability of being used on Low-E coatings in terms of color, surface, chemical durability, process, and the like.

The advantageous effects of the invention are not limited to the effects mentioned above. It should be understood that the effects of the present invention include all effects that can be inferred from the following description.

### BRIEF DESCRIPTION OF DRAWINGS

FIG. 1 shows a color change of an enamel according to tempering time, while a glass pane printed with an enamel composition including a glass frit having the composition of Table 1 was tempered at 700° C.

FIG. 2 shows a comparison of a yellow shift effect of an enamel coating on single Low-E glass and double Low-E glass.

FIG. 3 shows a comparison of color and surface state of enamel coated on Low-E glass according to the content of black pigment.

FIG. 4 is a schematic representation showing a phenomenon in which a transition metal oxide becomes brittle due to unstable grain boundaries generated between networks of glass frit.

FIG. 5 is a graph showing the values of Rg a* or Rg b* (Y-axis) according to tempering time (X-axis) of each coated enamel of the compositions shown in Table 3.

### MODE FOR THE INVENTION

Hereinafter, the present invention will be described in detail. However, the scope of the present invention is not limited thereto.

In the present description, “including” or “comprising” means that other components may be further included unless otherwise specified.

Black enamel is often applied to a substrate or article with a silver-based Low-E coating. As shown in Example 1, while an enamel is formed on the Low-E coating and performed tempering heat treatment, as a heat treatment time increases, the color of the enamel changes to yellowish-brown, making it impossible to produce a required black enamel in some cases. This is due to a yellow shift phenomenon in which silver in the Low-E coating dissolves toward the enamel during tempering and becomes yellowish-brown due to redox reaction. The yellow shift effect may appear more severely in enamel on multi-Low-E coating in which a plurality of silver layers are present, which was confirmed in Example 2 of the present description.

Accordingly, the present invention provides enamel compositions capable of having a black color and opacity within a required range even after tempering when forming an enamel on a Low-E coated substrate or article.

A simple way to make a black enamel would be mixing a glass frit and a black pigment with an organic vehicle to make a composition for enamel formation. As shown in Example 3, when the enamel was formed on the Low-E coated glass, if a black pigment was added to an enamel-forming composition, the yellow shift phenomenon could be suppressed. However, the quality of the surface of the formed enamel was deteriorated and the chemical durability was weakened in case that the content of the black pigment in the enamel composition increased.

The inventors of the present invention solved this problem by introducing transition metal oxides, which make enamel color, into a frit network of other metal oxides for forming the glass frit. As shown in Example 4, the enamel coatings with the compositions in which the metal oxides Co₃O₄, NiO₂, and Fe₂O₃ were introduced into the glass frit suppressed the yellow shift, so that the CIELAB color coordinate values were within the acceptable range, and the surface roughness(Ra) as well as the chemical durability were excellent.

However, when a black pigment was not included in the compositions, the transmittance was higher than the allowable range and the opacity was beyond the allowable range, and as shown in Example 5, the process margin was very small in terms of color change as the tempering time increased, which results in limitations.

Therefore, based upon the above idea and in consideration of the color, opacity, surface quality, chemical durability, and process margin of the enamel, the inventors of the present invention found enamel compositions containing the metal oxides Co₃O₄, NiO₂, and Fe₂O₃ that were introduced into a glass frit while using the minimum amount of black pigment as possible.

The enamel compositions according to the present invention are characterized in that, to express a black color, they include transition metal oxides added as a member of a network of glass frit and a black pigment that is physically mixed with the glass frit.

In an embodiment according to the present invention, an enamel composition includes a glass frit, a black pigment, and a vehicle, wherein the glass frit contains 50 to 70 wt % of Bi₂O₃, 7.0 to 10.0 wt % of SiO₂, 6.0 to 8.0 wt % of B₂O₃, 10.0 to 15.0 wt % of ZnO, 1.0 to 2.0 wt % of Al₂O₃ and 3.2 to 10.9 wt % of the total of Co₃O₄, NiO₂ and Fe₂O₃ relative to the total weight of the glass frit, and the black pigment may be 3 to 10% by weight relative to the total weight of the glass frit.

More preferably, an enamel composition according to the present invention includes a glass frit, a black pigment, and a vehicle, wherein the glass frit contains 50 to 60 wt % of Bi₂O₃, 8.0 to 9.0 wt % of SiO₂, 6.5 to 8.0 wt % of B₂O₃, 12.0 to 15.0 wt % of ZnO, 1.0 to 2.0 wt % of Al₂O₃ and 3.2 to 10.9 wt % of the total of Co₃O₄, NiO₂ and Fe₂O₃ relative to the total weight of the glass frit, and the black pigment may be 3 to 10% by weight relative to the total weight of the glass frit.

In an embodiment of an enamel composition according to the present invention, Co₃O₄, NiO₂ and Fe₂O₃ are contained in the glass frit, and the content of Co₃O₄ may be 3.0-6.0 wt %, the NiO₂ content may be 0.1-3.0 wt %, and the Fe₂O₃ content may be 0.1 to 5.0 wt % with respect to the total weight of the glass frit.

In addition, in an embodiment of an enamel composition according to the present invention, at least one selected from TiO₂ and Na₂O may be further included in the glass frit in an amount of 0.1 to 3.0 wt % respectively with regard to the total weight of the glass frit.

Na₂O plays a role in lowering the melting point of glass and increasing fluidity, but it is known that chemical durability decreases if an excessive amount is employed. Compositions of the present invention contain Na₂O in an amount that does not lower chemical durability while increasing the fluidity reduced by transition metal oxides contained in glass frits.

Furthermore, in an embodiment of an enamel composition according to the present invention, the a black pigment in the enamel composition contains Cr, and it may include one or more compounds selected from compounds containing at least one of Zn, Fe, and Cu. Black pigments that can be used in enamel compositions are well known in the art and are commercially available. Examples are CuCr₂O₄, (Co, Fe) (Fe, Cr)₂O₄, and the like. For example, there are *2991 pigment (copper chromite black pigment), *2980 pigment (cobalt chromium iron black pigment), *2987 pigment (nickel manganese iron chromium black pigment) available from Cerdec Corporation.

In an embodiment of a glass frit included in an enamel composition, the glass frit can be produced by melting components of the glass frit included in the enamel composition at a high temperature (about 900° C. to 1600° C.), and then rapidly cooling the molten glass by water or by pouring the molten glass between two cooling metal rolls rotating in opposite directions. Melting is generally carried out, for example, in ceramic or platinum crucibles or in suitably lined furnaces. The resulting frit fragments, chips, or flakes can be manufactured into fine grain sizes using a ball mill or the like.

An enamel composition may comprise a glass frit, a pigment and a vehicle. In one embodiment, the enamel composition may further include additives such as a dispersant, a leveling agent, an anti-bubble agent, or an anti-settling agent.

A glass frit can be mixed with a vehicle to make a printable enamel paste. The vehicle can be appropriately selected according to applications. In one embodiment, the vehicle properly suspends the particles and completely burns away when firing the paste on a substrate. The vehicle is usually an organic medium, for example, mineral oil, pine oil, vegetable oil, low-molecular petroleum fraction, and the like can be used.

To make an enamel composition, glass frit and other solid materials are mixed, liquid components are added thereto, and then they are thoroughly mixed or kneaded to form a paste. This paste can be further dispersed using a typical apparatus such as a disperser or a roll mill. The enamel composition can be applied to a substrate by screen printing, spraying, brushing, roller coating, sputtering coating, pyrolytic coating, and the like. After applying the enamel paste to the substrate in a desired pattern, it is fired so that the enamel adheres to the substrate. The firing temperature is generally determined according to the frit ripening temperature, and in one embodiment, it may be in the range of 600 to 760° C.

In one embodiment of an enamel-coated article according to the present invention, it includes a substrate, a Low-E coating formed on the substrate, and a pattern portion in which a black enamel coating is formed in a predetermined pattern on at least a part of the Low-E coated substrate, where the black enamel coating is formed of the enamel composition according to the present invention, and the Low-E coating of the portion on which the enamel coating is formed may be removed by a chemical reaction with the enamel coating.

In addition, in one embodiment, the thickness of a black enamel coating of an enamel-coated article according to the present invention may be 5 μm to 15 μm, and the surface roughness(Ra) of the enamel coating may be less than 1 μm. The surface roughness of the enamel coating can be measured using, for example, a stylus type surface roughness meter or a non-contact surface roughness meter.

In addition, in one embodiment, the glass side reflection color of the enamel coating of an enamel-coated article according to the present invention is in the range of −1.0 to 1.0 respectively of the CIELAB color coordinates a* and b*.

In the context of the present invention, the term “chemical durability” refers to the ability to resist degradation upon exposure to specified chemical conditions. Specifically, the chemical durability of an enamel-coated article described in this description was evaluated by an acid resistance test. After the specimen was immersed in 0.1N HCl at 25° C. for 3 minutes, and washed with deionized water, the grade was evaluated according to the test method as defined in the Standard Test Method for Acid Resistance of Ceramic Decorations on Architectural Type Glass (ASTM C724-91) as follows:

Grade 1:No damage

Grade 2:Loss of glossing

Grade 3:Obvious matting, color changed but not severe

Grade 4:Severe color change, chocking available, scratch not resistant or wiped off when washing

Grade 5:Full dissolution/delamination of surface

In one embodiment of an enamel-coated article according to the present invention, the enamel-coated article prepared by tempering at 700° C. for 200-600 seconds was immersed in 0.1 N HCl at 25° C. for 3 minutes, and then washed with deionized water. The chemical durability of the coated article after washed was evaluated as grade 3 or less according to the above-described grades.

In one embodiment, the present invention relates to a method of manufacturing an enamel-coated article comprising the step of printing a black enamel composition according to the present invention to have a predetermined pattern on at least a portion of the Low-E coated substrate; and the step of forming a pattern portion including a black enamel coating by heat treatment of the substrate on which the enamel composition is printed. The heat treatment may be performed for 150 seconds to 600 seconds at a temperature of 500° C. to 760° C. The heat treatment may be a tempering process of the substrate.

Hereinafter, the present invention will be described in more detail based on examples. However, the present invention is not limited by the following examples. Embodiments of the present invention may be modified in various forms unless the gist of the invention is changed.

### Example 1 Changes in Color of an Enamel on Low-E Coating According to Tempering Time

Oxides with the weight ratio shown in Table 1 below are melted at a high temperature (1000° C. or higher) to produce a glass frit, and then the frit is milled using a ball mill to produce 8-12 micrometers-sized particles.

TABLE 1

| SiO₂ | B₂O₃ | Bi₂O₃ | ZnO | Al₂O₃ |
|---|---|---|---|---|
| 9.0 wt % | 7.0 wt % | 68.4 wt % | 13.6 wt % | 2.0 wt % |

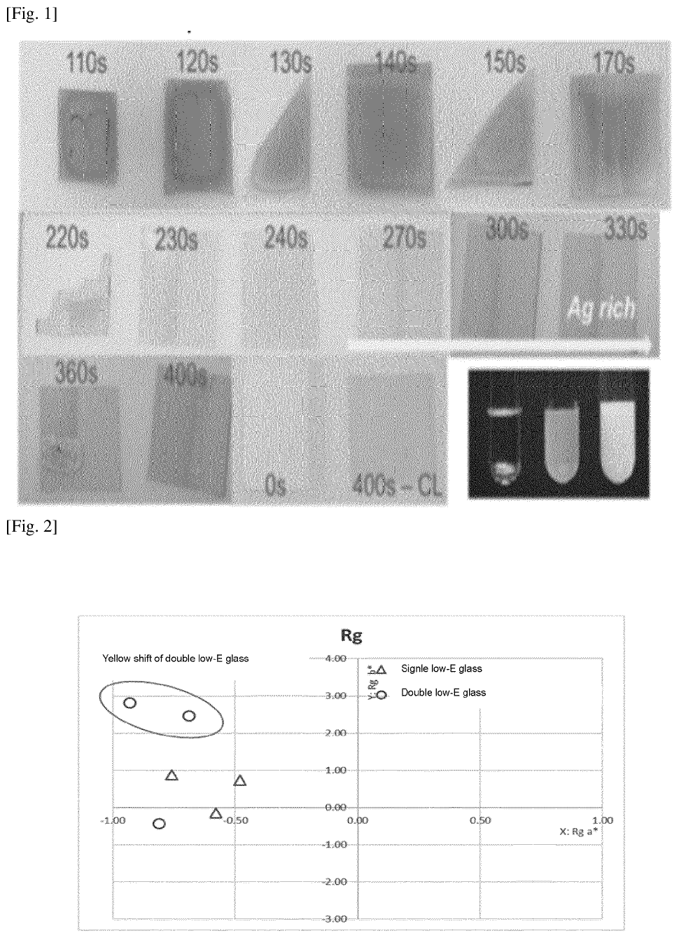

The milled glass frit was mixed with alcohol and ethyl cellulose to form a paste, and then applied to a single Low-E glass by screen printing. The glass plate on which an enamel composition was applied was tempered at 700° C., and the color of the glass on which the enamel was applied was observed according to tempering time (seconds) (FIG. 1).

Before tempering (0 s in FIG. 1), the coated enamel was transparent and was the color of the glass itself, but it can be seen that the color changes as the tempering time is increased, and the color is clearly a yellowish brown color in 400 s.

The lower right blue panel of FIG. 1 shows the color change with each concentration when the silver colloid concentration is increased toward the right test tube, from which it can be seen that the silver nanoparticles have a yellowish brown color.

When Bi-based enamel paste is printed on Low-E glass and fired, silver in the silver layer of the Low-E coating is dissolved out and a redox reaction occurs as the tempering time increases. During tempering, silver ions dissolve into a soft enamel phase.

Ag->Ag+(Dissolved, Fast, Unstable)

Since Ag has a high reduction potential, silver ions are relatively unstable even in the enamel phase. Since the solubility and dissolution capacity of silver in the enamel should be very low, a slow and gradient redox reaction occurs as the total heating time increases, and the silver becomes yellowish brown, and other silver will dissolve at the same time.

Ag+->Ag (redox, slow, yellow shift) Therefore, the yellow shift effect may appear more severely in the enamel on a multi Low-E coating in which a plurality of silver layers exist, which was confirmed in Example 2 below.

### Example 2 Comparison of the Yellow Shift Effect of an Enamel Coating on Single Low-E Glass and Double Low-E Glass

The enamel composition prepared in Example 1 was applied to single Low-E glass and double Low-E glass, then tempered at 700° C. for 210 seconds, 260 seconds, and 310 seconds, and CIELAB color coordinates a* and b* were measured with Minolta CM600 and shown as a graph (FIG. 2).

Within the range of the experimental conditions, the CIELAB color coordinate values of the enamel coated on the single Low-E glass were between −1.0 to 1.0, respectively which are within the allowable ranges of Rg a* and Rg b*, but the color coordinate values of the enamel coated on the double Ro-E glass were outside the allowable ranges of Rg a* and Rg b*, at a tempering time of 260 seconds and 310 seconds.

### Example 3 Effect of Adding Black Pigment to an Enamel Coated on Low-E Glass

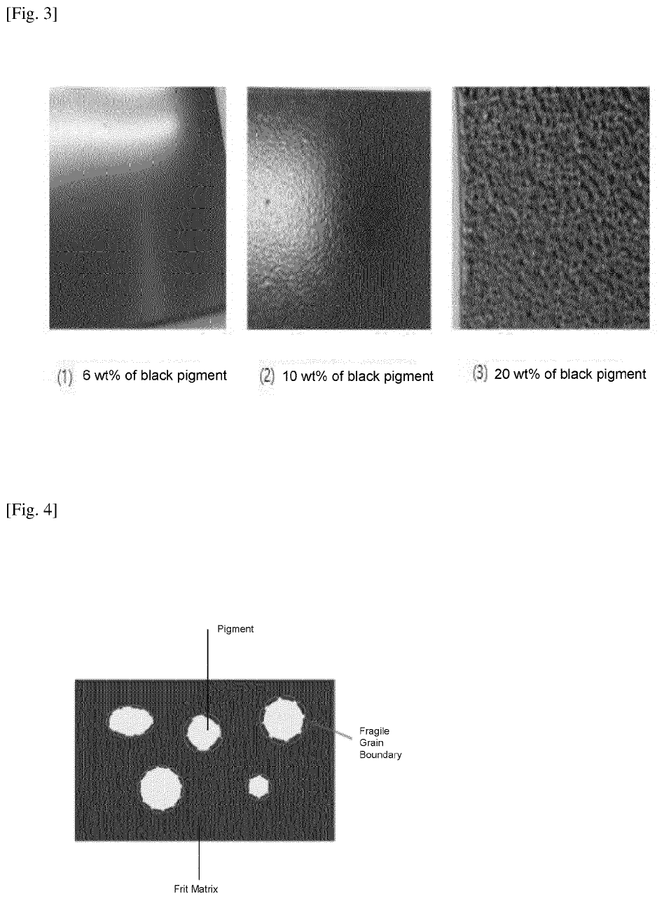

In order to suppress the yellow shift phenomenon due to tempering of the enamel coated on the Low-E glass, the glass frit having the composition of Table 1 and 6 wt %, 10 wt %, or 20 wt % of black pigment (mainly composed of CuCr₂O₄, spinel structure) relative to the total weight of the glass frit, was applied to a single Low-E glass according to the method of Example 1 and tempered at 700° C. for 230 seconds. FIG. 3 is a comparison after tempering the enamel coating surfaces comprising each amount of black pigment as above.

As shown in FIG. 3, when a black pigment was added, the color of the enamel after tempering appeared vivid black. However, the coating surface formed of the enamel composition containing 6% by weight of the black pigment based on the total weight of the glass frit was smooth ((1) in FIG. 3), and in the condition when containing 10% by weight of the black pigment the surface roughness (Ra) was maintained within the permissible range ((2) in FIG. 3), and bubbles were severely formed on the surface in the condition when containing 20% by weight of the black pigment ((3) in FIG. 3). Most of the pigments are made of transition metal oxides, which increase the viscosity of the glass frit when the temperature increases, so bubbles are generated on the surface and the surface is not slippery.

Also, transition metal oxides are easily soluble in an acidic environment because ionic bonds are formed inside of the transition metal oxides, thereby generating an unstable grain boundary between the transition metal oxides and a network of glass frit, thus becoming brittle (FIG. 4). Therefore, when the content of the black pigment is increased, the chemical durability of the enamel is weakened.

An enamel composition containing 15% by weight of a glass frit having the composition of Table 1 and a black pigment (mainly composed of CuCr₂O₄, spinel structure) based on the total weight of the glass frit was applied to a single Low-E glass according to the method of Example 1, then tempered at 700° C. for 230 seconds. Within the range of the experimental conditions, the CIELAB color coordinate values of the enamel coated on the Low-E glass were measured to be −0.5 and −0.2, respectively, within the allowable ranges of Rg a* and Rg b* (Minolta CM600), and the surface roughness(Ra) was good with 0.1 μm (measured with Sufcom JIS094 standard, 0.15 mm/s, 3.0 mm).

However, the chemical durability evaluated by the acid resistance was measured very low with Grade 5 (complete dissolution/peeling of the surface). To evaluate the chemical durability, the specimen was immersed in 0.1N HCl at 25° C. for 3 minutes, washed with deionized water, and a grade was evaluated with reference to the evaluation criteria as described in the Standard Test Method for Acid Resistance of Ceramic Decorations on Architectural Type Glass Test Method (ASTM C724-91).

Grade 1:No damage

Grade 2:Loss of glossing

Grade 3:Obvious matting, color changed but not severe

Grade 4:Severe color change, chocking available, scratch not resistant or wiped off when washing

Grade 5:Full dissolution/delamination of surface

### Example 4 Enamel Compositions in which Transition Metal Oxides were Directly Inserted into Frit Network

In order for an enamel to exhibit a predetermined color, there is a method of physically mixing a pigment with a glass frit as in Example 3, and another method is to directly insert transition metal oxides into a frit network. When metal oxides are melted above the melting point with other compounds in a glass frit, it not only contributes to the color of the enamel, but also replaces the role of ZnO to make it chemically stronger.

By including metal oxides Co₃O₄, NiO₂, and Fe₂O₃ into a glass frit, the glass frit was prepared according to the method of Example 1 with the compositions shown in Table 2, and enamel compositions were prepared with a vehicle, etc., and coated on a single Low-E glass, and tempered at 700° C. for 230 seconds.

TABLE 2

| | Sample 1 | Sample 2 | Sample 3 |
|---|---|---|---|
| Glass frit | | | |
| SiO₂ (wt % in the glass frit) | 8.7 | 8.6 | 8.6 |
| B₂O₃ (wt % in the glass frit) | 6.8 | 7.7 | 7.7 |
| Bi₂O₃ (wt % in the glass frit) | 66 | 51.5 | 51.5 |
| ZnO (wt % in the glass frit) | 10.7 | 14.9 | 14.9 |
| A1₂O₃ (wt % in the glass frit) | 1.9 | 2.0 | 2.0 |
| Co₃O₄ (wt % in the glass frit) | 3.3 | 5.8 | 5.8 |
| NiO₂ (wt % in the glass frit) | 1.3 | 1.2 | 1.2 |
| Fe₂O₃ (wt % in the glass frit) | 1.1 | 3.9 | 3.9 |
| Na₂O (wt % in the glass frit) | | 3.0 | 3.0 |
| TiO₂ (wt % in the glass frit) | | 1.6 | 1.6 |
| Pigment (wt % of total glass frit weight) | 0.0 | 0.0 | 6.3 |

The transmittance (Perkin-Elmer Lambda1050), CIELAB color coordinate values (Minolta CM600), and surface roughness(Ra) (Sufcom JIS-94 standard, 0.15 mm/s, 3.0 mm) of the enamel-coated Low-E glass were measured. In addition, chemical durability was evaluated according to the method described in Example 3.

TABLE 3

| Properties | Allowable range | Sample 1 | Sample 2 | Sample 3 |
|---|---|---|---|---|
| Transmittance(T) | T < 0.1% | | 3.5 | 0.09 |
| a*Rg | −1.0 < a*Rg < 1.0 | 0.38 | 0.6 | 0.1 |
| b*Rg | −1.0 < b*Rg < 1.0 | 0.03 | −0.3 | −0.3 |
| Ra | Ra < 0.5 μm | 0.21 | 0.1 | 0.1 |
| Chemical durability | Grade 3 or less | Grade 3 | Grade 3 | Grade 3 |

The enamel coating of the compositions of Table 2 in which metal oxides Co₃O₄, NiO₂ and Fe₂O₃ were introduced into the glass frit was excellent in chemical durability as well as CIELAB color coordinate values and surface roughness(Ra). However, when the pigment was not included, the transmittance was higher than the allowable range.

### Example 5 Formulations of Enamel Compositions and Process Margin

Enamel compositions were prepared according to the method of Example 4 with the compositions shown in Table 4, coated on a single Low-E glass, tempered at 700° C. for 230 seconds, and the properties of each enamel coating were measured.

TABLE 4

| | Sample 1 | Sample 3 | Sample 4 |
|---|---|---|---|
| Glass frit | | | |
| SiO₂ (wt % in the glass frit) | 8.7 | 8.6 | 9.0 |
| B₂O₃ (wt % in the glass frit) | 6.8 | 7.7 | 7.0 |
| Bi₂O₃ (wt % in the glass frit) | 66 | 51.5 | 68.4 |
| ZnO (wt % in the glass frit) | 10.7 | 14.9 | 13.6 |
| Al₂O₃ (wt % in the glass frit) | 1.9 | 2.0 | 2.0 |
| Co₃O₄ (wt % in the glass frit) | 3.3 | 5.8 | |
| NiO₂ (wt % in the glass frit) | 1.3 | 1.2 | |
| Fe₂O₃ (wt % in the glass frit) | 1.1 | 3.9 | |
| Na₂O (wt % in the glass frit) | | 3.0 | |
| TiO₂ (wt % in the glass frit) | | 1.6 | |
| Pigment (wt % of total glass frit | 0.0 | 6.3 | 6.5 |
| weight) | | | |

Further, the enamel coating prepared with the same compositions was tempered for 200 seconds, 230 seconds, 260 seconds, 300 seconds, 420 seconds, and 600 seconds at 700° C. in a Northglass furnace. The process margin was calculated in the range of the tempering time with an absolute value less than 1 of the CIELAB color coordinate values (Rg a* or Rg b*).

TABLE 5

| Properties | Allowable range | Sample 1 | Sample 3 | Sample 4 |
|---|---|---|---|---|
| Transmittance(T) | T < 0.1% | | 0.09 | 0.09 |
| a*Rg | −1.0 < a*Rg < 1.0 | 0.38 | 0.1 | −0.49 |
| b*Rg | −1.0 < b*Rg < 1.0 | 0.03 | −0.3 | −0.96 |
| Ra | Ra < 0.5 μm | 0.21 | 0.1 | 0.11 |
| Chemical durability | Grade 3 or less | Grade 3 | Grade 3 | Grade 4 |
| Process margin(sec) | | 60 | 400 | 60 |

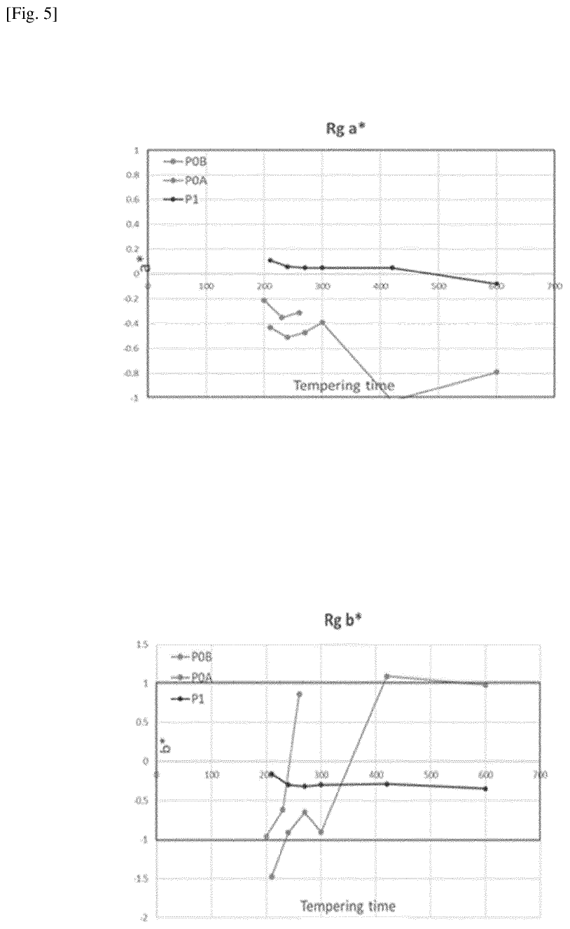

FIG. 5 is a graph showing CIELAB color coordinate values Rg a* or Rg b* (Y-axis) according to the tempering time (X-axis) of each coated enamel.

From the graph of FIG. 5, it can be seen that Samples 1 and 4 deviate from the allowable area in +(yellow direction) the Rg b* area as the tempering time increases, or the margin is significantly smaller with 60 seconds. On the other hand, Sample 3 maintained a stable color during test from 200 seconds to 600 seconds, regardless of the tempering time, and the process margin was significantly larger with 400 seconds than Samples 1 and 4.

The present invention has been described in detail above, and the scope of the present invention is not limited to the above-described embodiments. The basic concept of the present invention and the invention defined in the detailed description and claims, and modifications and improvements using the same are also included in the scope of the present invention.

The black enamel composition according to the present invention can be used in various articles that need to form a black enamel on a Low-E coated substrate based on silver, and thus can be used in various fields such as automobiles and construction.

1. A black enamel composition comprising a glass frit, a black pigment and an organic vehicle, wherein the glass frit comprises 50 to 70 wt % of Bi₂O₃, 7.0 to 10.0 wt % of SiO₂, 6.0 to 8.0 wt % of B₂O₃, 10.0 to 15.0 wt % of ZnO, 1.0 to 2.0 wt % of Al₂O₃, 3.2 to 10.9 wt % of the total of Co₃O₄, NiO₂ and Fe₂O₃, based on the total weight of the glass frit, wherein the black pigment is 3 to 10 wt % relative to the total weight of the glass frit.

2. The black enamel composition according to claim 1, wherein the Co₃O₄ content is 3.0 to 6.0 wt %, the NiO₂ content is 0.1 to 3.0 wt % and the Fe₂O₃ content is 0.1 to 5.0 wt % relative to the total weight of the glass frit.

3. The black enamel composition according to claim 1, wherein the glass frit further comprises at least one selected from TiO₂ and Na₂O in an amount of 0.1 to 3.0 wt % relative to the total weight of the glass frit.

4. The black enamel composition according to claim 1, wherein the black pigment comprises Cr and one or more compounds are selected from compounds comprising at least one of Zn, Fe, and Cu.

5. The black enamel composition according to claim 3, wherein the glass frit comprises 50 to 70 wt % of Bi₂O₃, 7.0 to 10.0 wt % of SiO₂, 6.0 to 8.0 wt % of B₂O₃, 10.0 to 15.0 wt % of ZnO, 1.0 to 2.0 wt % of Al₂O₃, 3.0-6.0 wt % of Co₃O₄, 0.1-3.0 wt % of NiO₂, 0.1-5.0 wt % of Fe₂O₃, 0.1-3.0 wt % of TiO₂ and 0.1-3.0 wt % of Na₂O relative to the total weight of the glass frit, wherein the black pigment is 3 to 10 wt % relative to the total weight of the glass frit.

6. A coated article comprising a substrate, a Low-E coating formed on the substrate, and a pattern portion having a black enamel coating formed in a predetermined pattern on at least a portion of the Low-E coated substrate, wherein the black enamel coating is formed of the black enamel composition of claim 1, and the Low-E coating of the portion where the enamel coating is formed can be at least partially removed by chemical reaction with the enamel coating.

7. The coated article according to claim 6, wherein a surface roughness (Ra) of the black enamel coating is less than 1 μm.

8. The coated article according to claim 6, wherein a glass side reflection color of the black enamel coating has CIELAB color coordinates a* and b* from −1.0 to 1.0 respectively.

9. The coated article according to claim 6, wherein the enamel coated article is prepared by tempering at 700° C. for 200˜600 seconds; and the chemical durability of the enamel coated article is less than or equal to Grade 3 when the coated article is exposed to 0.1N HCl at 25° C. for 3 minutes and washed with deionized water and then the acid resistance of the coated article is evaluated with reference to Standard Test Method for Acid Resistance of Ceramic Decorations on Architectural Type Glass (ASTM C724-91).
